(19) United States
(12) Patent Application Publication
(10) Pub. No.: US 2013/0058671 A1
(43) Pub. Date: Mar. 7, 2013

(54) IMAGE FORMING APPARATUS AND IMAGE FORMING METHOD

(71) Applicants: Ayaka MIYOSHI, Kanagawa (JP); Yoshihisa NAKAO, Kanagawa (JP)

(72) Inventors: Ayaka MIYOSHI, Kanagawa (JP); Yoshihisa NAKAO, Kanagawa (JP)

(73) Assignee: FUJI XEROX CO., LTD., Tokyo (JP)

(21) Appl. No.: 13/401,405

(22) Filed: Feb. 21, 2012

(30) Foreign Application Priority Data
Sep. 2, 2011 (JP) 2011-191747

(51) Int. Cl. G03G 15/16

(52) U.S. Cl. 399/66

(57) ABSTRACT

An image forming apparatus includes an image holding member, a transfer unit, a current detector, and a constant voltage controller. A toner image is held on the image holding member. The transfer unit transfers the toner image held on the image holding member onto a recording medium. The current detector detects a transfer current passed to the transfer unit. When images are to be successively formed on recording media, the constant voltage controller performs constant voltage control on a transfer voltage to be applied to the transfer unit when a first image is to be formed, and performs constant voltage control on a transfer voltage to be applied to the transfer unit when a second image is to be formed, using a voltage value corresponding to a current value detected by the current detector when the first image is to be formed.

### CROSS-REFERENCE TO RELATED APPLICATIONS

This application is based on and claims priority under 35 USC 119 from Japanese Patent Application No. 2011-191747 filed Sep. 2, 2011.

### BACKGROUND

(i) Technical Field

The present invention relates to an image forming apparatus and an image forming method.

### SUMMARY

According to an aspect of the invention, there is provided an image forming apparatus including an image holding member, a transfer unit, a current detector, and a constant voltage controller. A toner image is held on the image holding member. The transfer unit transfers the toner image held on the image holding member onto a recording medium. The current detector detects a transfer current passed to the transfer unit. When images including a first image and a second image are to be successively formed on recording media, the constant voltage controller performs constant voltage control on a transfer voltage to be applied to the transfer unit when the first image is to be formed, and performs constant voltage control on a transfer voltage to be applied to the transfer unit when the second image is to be formed, using a voltage value corresponding to a current value detected by the current detector. The current value is a value of a transfer current passed to the transfer unit when the first image is formed.

### BRIEF DESCRIPTION OF THE DRAWINGS

Exemplary embodiment(s) of the present invention will be described in detail based on the following figures, wherein:

FIG. 1 is a block diagram illustrating a control circuit for an image forming apparatus according to a first exemplary embodiment of the present invention;

FIG. 2 illustrates the image forming apparatus according to the first exemplary embodiment of the present invention;

FIG. 3 illustrates an image forming unit of the image forming apparatus according to the first exemplary embodiment of the present invention;

FIG. 4 illustrates toner images held on an intermediate transfer belt;

FIG. 5 schematically illustrates toner images formed on recording paper;

FIGS. 6A and 6B schematically illustrate images successively formed on sheets of recording paper;

FIG. 7 is a graph illustrating constant voltage control and constant current control identified in an image forming apparatus of the related art;

FIG. 8 is a graph illustrating changes in transfer voltage and transfer current in an image forming apparatus of the related art;

FIG. 9 is a graph illustrating changes in image density in an image forming apparatus of the related art;

FIG. 10 is a graph illustrating changes in transfer voltage and transfer current in the image forming apparatus according to the first exemplary embodiment of the present invention;

FIG. 11 is a graph illustrating changes in image density in the image forming apparatus according to the first exemplary embodiment of the present invention; and

FIG. 12 is a graph illustrating the occurrence of degradation in image quality.

### DETAILED DESCRIPTION

Exemplary embodiments of the present invention will be described hereinafter with reference to the drawings.

First Exemplary Embodiment

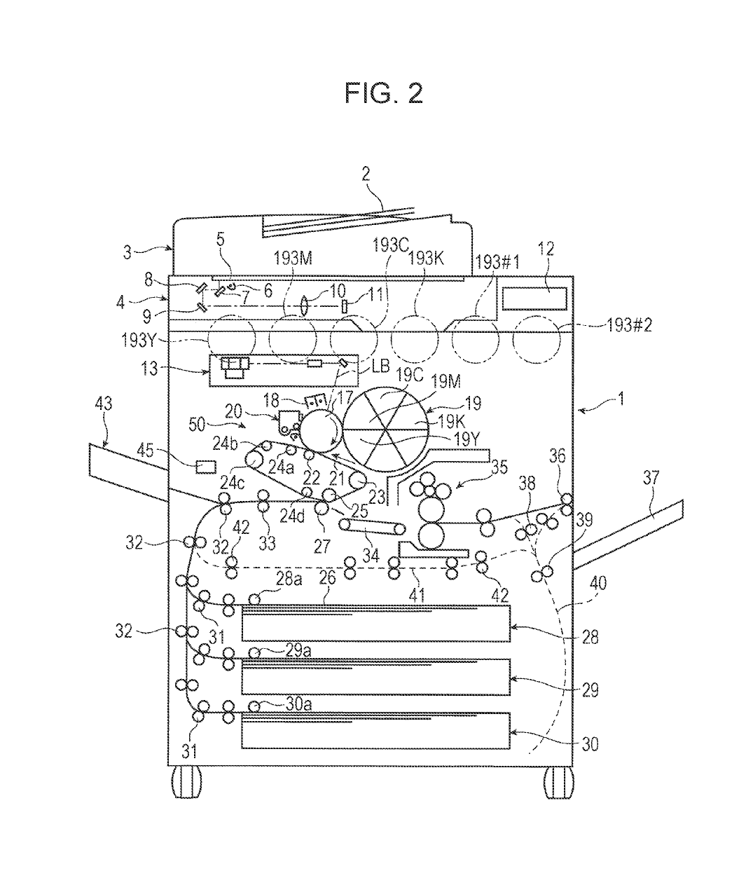

FIG. 2 schematically illustrates a four-cycle color image forming apparatus which may be an image forming apparatus according to a first exemplary embodiment of the present invention. The color image forming apparatus includes an image reading device, and may function as a full-color copying machine or a facsimile machine. The color image forming apparatus may also function as a printer that forms an image based on image data output from a personal computer or the like (not illustrated). As illustrated in FIG. 2, the image forming apparatus is connected to a personal computer 300 serving as a control device through a communication line 306, and is configured to form an image based on image data output from the personal computer 300. The image forming apparatus is also configured to adjust image quality in accordance with a control signal output from the personal computer 300.

In FIG. 2, an image forming apparatus body 1 includes in its upper portion an automatic document transport device 3 and an image reading device 4. The automatic document transport device 3 automatically transports originals 2 separately, one by one, to the image reading device 4. The image reading device 4 reads an image of an original 2 transported by the automatic document transport device 3. In the image reading device 4, an original 2 placed on a platen glass 5 is irradiated with light emitted by a light source 6, and a light image reflected from the original 2 is scanned and exposed onto an image reading element 11 including a charge-coupled device (CCD) sensor through a reduction optical system including a full-rate mirror 7, half-rate mirrors 8 and 9, and an imaging lens 10. The image reading element 11 reads the image of the original 2 in a predetermined dot density.

The image of the original 2 which has been read by the image reading device 4 is sent to an image processing device 12 as, for example, image data of three colors including red (R), green (G), and blue (B) (8 bits for each color). The image processing device 12 performs predetermined image processing, such as shading correction, misalignment correction, brightness/color space conversion, gamma correction, frame erase, and color/movement edition, on the image data of the original 2, as desired, to obtain image data of four colors including yellow (Y), magenta (M), cyan (C), and black (K).

The image data subjected to the predetermined image processing described above by the image processing device 12 is sequentially sent to an image exposure device 13 as image data corresponding to the four colors including yellow (Y), magenta (M), cyan (C), and black (K). The image exposure device 13 performs image exposure using laser beams in accordance with the image data. The image forming apparatus may also function as a printer. When the image forming apparatus functions as a printer, image data is input to the image processing device 12 from a host computer (not illustrated) such as a personal computer, and the image processing device 12 performs predetermined image processing, as desired. After that, image data corresponding to the four colors is sequentially output to the image exposure device 13.

The image forming apparatus body 1 includes an image forming unit 50 configured to sequentially form plural toner images having different colors. The image forming unit 50 generally includes a photoconductor drum 17, a scorotron charging device 18, the image exposure device 13, a rotary developing device 19, and a cleaning device 20. The photoconductor drum 17 serves as an image holding member that holds a toner image. The scorotron charging device 18 is one type of corona charging device having a grid electrode, which is an example of a charger that charges the surface of the photoconductor drum 17 at a predetermined potential. The image exposure device 13 serves as an electrostatic latent image forming unit that forms an electrostatic latent image in accordance with image data by performing image exposure on the surface of the photoconductor drum 17. The rotary developing device 19 serves as a developing unit that sequentially develops the electrostatic latent image formed on the surface of the photoconductor drum 17 using plural toners of different colors to form plural toner images of different colors. The cleaning device 20 serves as a cleaner that cleans the surface of the photoconductor drum 17. The charger 18 is not limited to a corona charging device and may be a roller-shaped charging member.

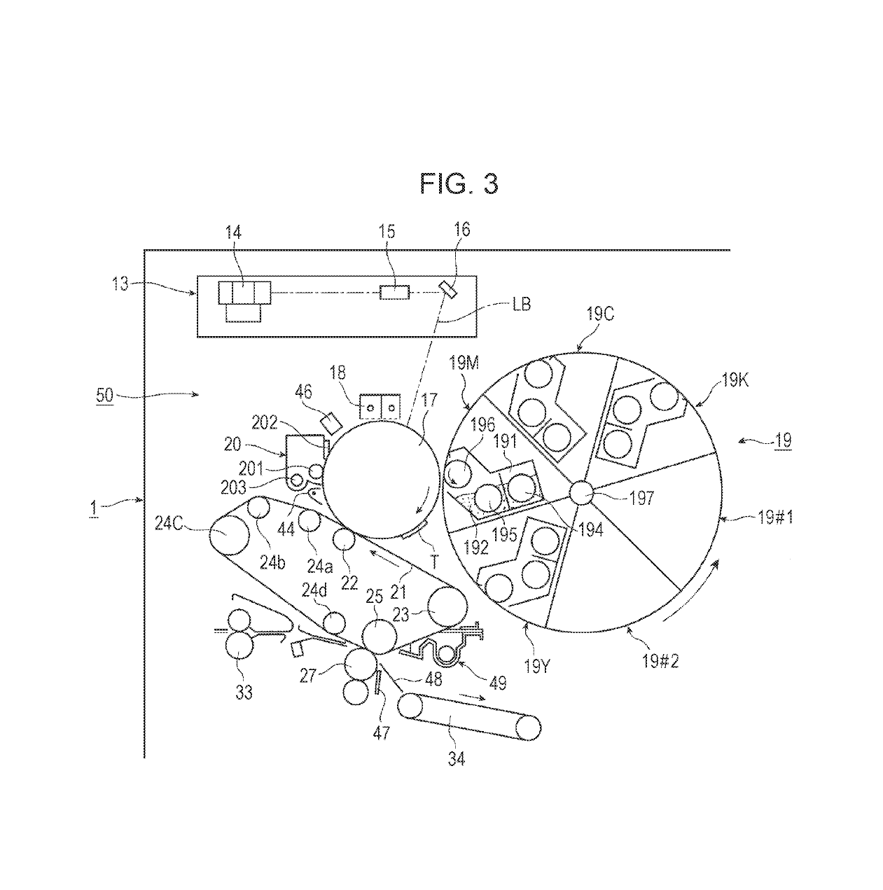

As illustrated in FIG. 3, the image exposure device 13 modulates a semiconductor laser (not illustrated) in accordance with image data, and the semiconductor laser emits a laser beam LB in accordance with the image data. The laser beam LB emitted from the semiconductor laser is polarized and scanned by a rotating polygon mirror 14, and is scanned and exposed onto the surface of the photoconductor drum 17 serving as an image holding member through an f.θ lens 15 and a reflecting mirror 16.

As illustrated in FIG. 2, the photoconductor drum 17 onto which the laser beam LB is scanned and exposed by the image exposure device 13 is driven by a driver (not illustrated) to rotate in a direction indicated by an arrow at a predetermined speed (plural speeds, for example, 270 mm/sec, 110 mm/sec, etc.).

The surface of the photoconductor drum 17 is charged to a predetermined polarity (for example, negative polarity) and potential by the scorotron charging device 18 for first charging. After that, the laser beam LB is scanned and exposed in accordance with the image data to form an electrostatic latent image on the surface of the photoconductor drum 17 in accordance with the image data. The electrostatic latent image formed on the photoconductor drum 17 is reversely developed with, for example, toner charged to a negative polarity which is the same as the charging polarity of the photoconductor drum 17, by causing one developing unit of the rotary developing device 19 rotatably provided with developing units 19Y, 19M, 19C, and 19K of four colors including yellow (Y), magenta (M), cyan (C), and black (K) to move to a developing position facing the photoconductor drum 17, and becomes a toner image having a predetermined color. The rotary developing device 19 may include, in addition to the developing units 19Y, 19M, 19C, and 19K of four colors including yellow (Y), magenta (M), cyan (C), and black (K), up to two auxiliary developing units 19#1 and 19#2 corresponding to, for example, transparent toner (CT), light magenta (LM), light cyan (LC), etc. In this case, image data corresponding to transparent toner (CT), light magenta (LM), and light cyan (LC), etc. is generated by the image processing device 12.

As illustrated in FIG. 2, the toner images of the respective colors such as yellow (Y), magenta (M), cyan (C), and black (K) which are to be sequentially formed on the photoconductor drum 17 are subjected to first transfer by a first transfer roller 22 serving as a first transfer unit so that the toner images are transferred on top of one another onto an intermediate transfer belt 21 which may be an endless belt serving as an intermediate transfer body disposed below the photoconductor drum 17. The intermediate transfer belt 21 functions as an image holding member that holds the toner images transferred from the photoconductor drum 17. The intermediate transfer belt 21 is stretched over a driving roller 23, a first driven roller 24a, a second driven roller 24b, a tension applying roller 24c, a third driven roller 24d, and a counter roller 25 that is part of a second transfer unit, and is circularly driven in a direction indicated by an arrow at a speed substantially equal to the rotation speed of the photoconductor drum 17.

Toner images of all or some of the four colors including yellow (Y), magenta (M), cyan (C), and black (K) which are to be subsequently formed on the photoconductor drum 17 are transferred onto the intermediate transfer belt 21 by the first transfer roller 22 in a superimposed manner in accordance with the color of the image to be formed last. The toner images transferred onto the intermediate transfer belt 21 are subjected to second transfer by a second transfer roller 27 serving as a second transfer unit so that the toner images are collectively transferred onto recording paper 26 serving as a recording medium transported to a second transfer position at a predetermined timing by the counter roller 25 that supports the intermediate transfer belt 21 and by the second transfer roller 27 that is pressed against the counter roller 25 via the intermediate transfer belt 21. As illustrated in FIG. 2, the recording paper 26 is of the desired size and material and is fed from one of plural paper feed cassettes 28, 29, and 30 disposed in a lower portion of the image forming apparatus body 1 by paper feed rollers 28a, 29a, and 30a. In addition to plain paper, thick paper, coated paper, thin paper, or any other paper of the desired material may be fed from the plural paper feed cassettes 28, 29, and 30. The recording paper 26, such as plain paper, thick paper, coated paper, or thin paper, is classified by basis weight. The fed recording paper 26 is transported to the second transfer position of the intermediate transfer belt 21 at a predetermined timing by plural transport rollers 31 and 32 and a registration roller 33. Then, as described above, toner images of predetermined several colors are collectively transferred (second transfer) onto the recording paper 26 by the counter roller 25 and the second transfer roller 27 from the intermediate transfer belt 21.

The recording paper 26 onto which toner images of predetermined several colors have been transferred (second transfer) from the intermediate transfer belt 21 is separated from the intermediate transfer belt 21, and is then transported to a fixing device 35 by a transport belt 34. The fixing device 35 fixes unfixed toner images onto the recording paper 26 by heat and pressure. In a one-sided or simplex copying operation, the recording paper 26 is discharged onto a paper output tray 37 as it is by a discharge roller 36, and an image forming process for forming a color image, a monochrome image, or the like ends.

The image forming apparatus is configured to form images on both sides, or a first side and a second side, of the recording paper 26. The image forming apparatus includes a transport unit for two-sided or duplex printing that turns over the recording paper 26 with toner images fixed onto the first side thereof by the fixing device 35 and that transports the recording paper 26 back to the second transfer unit.

Specifically, when the image forming apparatus is to form images on both sides of the recording paper 26, as illustrated in FIG. 2, the recording paper 26 with a color image or the like formed on the first side (front side) thereof is turned over face down by a reverse gate (not illustrated), without being discharged directly onto the paper output tray 37, so that the transport direction is changed, and is transported to a reverse path 40 by a transport roller 38 and a reverse roller 39. The recording paper 26 is then transported to a duplex printing path 41 by the reverse roller 39 that reverses, and is transported to the registration roller 33 by a transport roller 42 disposed in the duplex printing path 41. The recording paper 26 is transported again by the registration roller 33 in synchronization with the toner images on the intermediate transfer belt 21, and a process for transferring and fixing toner images onto the second side (back side) of the recording paper 26 is performed. After that, the recording paper 26 is delivered onto the paper output tray 37.

In this exemplary embodiment, the transport unit for duplex printing includes the transport roller 38, the reverse roller 39, the reverse path 40, the duplex printing path 41, and the transport roller 42. However, the transport unit for duplex printing is not limited to this configuration, and may be configured in any other way as long as a recording medium with a toner image fixed onto the first side thereof by a fixing unit is reversed and is transported back to the transfer unit.

In FIG. 2, a manual paper tray 43 is used to manually feed the recording paper 26 of desired size and material.

FIG. 3 illustrates the image forming unit 50 of the image forming apparatus.

In the image forming apparatus, as described above, the surface of the photoconductor drum 17 is charged uniformly to a predetermined polarity and potential by the scorotron charging device 18 for first charging. After that, the surface of the photoconductor drum 17 is sequentially exposed to light by the image exposure device 13 to sequentially create images corresponding to predetermined colors, and electrostatic latent images are formed.

Then, as described above, as illustrated in FIG. 3, the electrostatic latent images sequentially formed on the surface of the photoconductor drum 17 in accordance with the respective colors are developed by the developing units 19Y, 19M, 19C, and 19K of the corresponding colors, and a toner image T of a predetermined color is formed on the surface of the photoconductor drum 17.

In the rotary developing device 19, as illustrated in FIG. 3, the developing units 19Y, 19M, 19C, and 19K of the respective colors, that is, yellow (Y), magenta (M), cyan (C), and black (K), are arranged along the periphery of the rotary developing device 19. The rotary developing device 19 is rotated about a rotation axis 197 in the direction indicated by an arrow, and therefore developing rollers 196 in the developing units 19Y, 19M, 19C, and 19K of the corresponding colors are moved to and stopped at a developing position facing the photoconductor drum 17 so that the electrostatic latent images formed on the surface of the photoconductor drum 17 are developed by the desired colors of toner.

As illustrated in FIG. 3, each of the developing units 19Y, 19M, 19C, and 19K may be, for example, a two-component developing unit that accommodates two-component developer 192 including toner and carriers in a developing unit body 191. In the developing unit body 191, toner is supplied from toner cartridges 193Y to 193K (see FIG. 2) at predetermined timings so that the toner density in the developing unit body 191 is maintained within a predetermined range. The toner supplied into the developing unit body 191 is agitated with the developer 192 in the developing unit body 191 by two developer agitation transport augers 194 and 195 for frictional charging, and is circulated, during which the toner is supplied to the developing roller 196. In addition, the toner is transported to a developing region facing the surface of the photoconductor drum 17 as a magnetic brush of the developer 192 formed on the surface of the developing roller 196, and is used to develop the electrostatic latent image formed on the surface of the photoconductor drum 17.

For example, if the electrostatic latent image formed on the photoconductor drum 17 is an electrostatic latent image of yellow, the electrostatic latent image is developed by the developing unit 19Y of yellow, and a toner image T of yellow is formed on the photoconductor drum 17. Also for the other colors, i.e., magenta, cyan, and black, a similar process is performed to sequentially form toner images T of the corresponding colors on the photoconductor drum 17.

The toner images T of the respective colors sequentially formed on the photoconductor drum 17 are subjected to first transfer at a first transfer position where the photoconductor drum 17 and the intermediate transfer belt 21 are in contact with each other, and are transferred onto the front surface of the intermediate transfer belt 21 from the photoconductor drum 17. The first transfer roller 22 is disposed at the first transfer position on the back surface of the intermediate transfer belt 21. The intermediate transfer belt 21 is brought into contact with the surface of the photoconductor drum 17 by the first transfer roller 22. A voltage of polarity (positive polarity) opposite to the charging polarity of toner is applied to the first transfer roller 22, and the toner image T formed on the photoconductor drum 17 is transferred (first transfer) onto the intermediate transfer belt 21.

When a single-color image is to be formed, a toner image T of a predetermined color which has been transferred (first transfer) onto the intermediate transfer belt 21 is immediately transferred (second transfer) onto the recording paper 26 at the second transfer position. When a color image in which toner images T of plural colors are superimposed on one another is to be formed, the process of forming a toner image T of a predetermined color on the photoconductor drum 17 and performing first transfer to transfer the toner image T in a superimposed manner onto the intermediate transfer belt 21 is repeatedly performed a number of times equal to the number of predetermined colors.

For example, when a full-color image in which toner images T of four colors including yellow (Y), magenta (M), cyan (C), and black (K) are superimposed on one another is to be formed, every rotation allows a toner image T of each of the respective colors, i.e., yellow (Y), magenta (M), cyan (C), or black (K), to be sequentially formed on the photoconductor drum 17, and the toner images of the four colors are sequentially transferred (first transfer) onto the intermediate transfer belt 21 in a superimposed manner.

As illustrated in FIG. 3, residual toner, an external additive of toner, or the like that remains without having been transferred (first transfer) from the photoconductor drum 17 onto the intermediate transfer belt 21 is subjected to charge removal by a pre-cleaning charge removing device 44, and is then cleaned by a cleaning device 20. The cleaning device 20 is configured to remove a residual material on the surface of the photoconductor drum 17, such as residual toner or an external additive of toner, by using a cleaning brush 201 and a cleaning blade 202, and to discharge the removed material such as toner to outside the cleaning device 20 at a predetermined timing by using a transport auger 203. The surface of the photoconductor drum 17 which has been cleaned by the cleaning device 20 is uniformly exposed to light by an erase lamp 46 to remove charge for the subsequent image forming process.

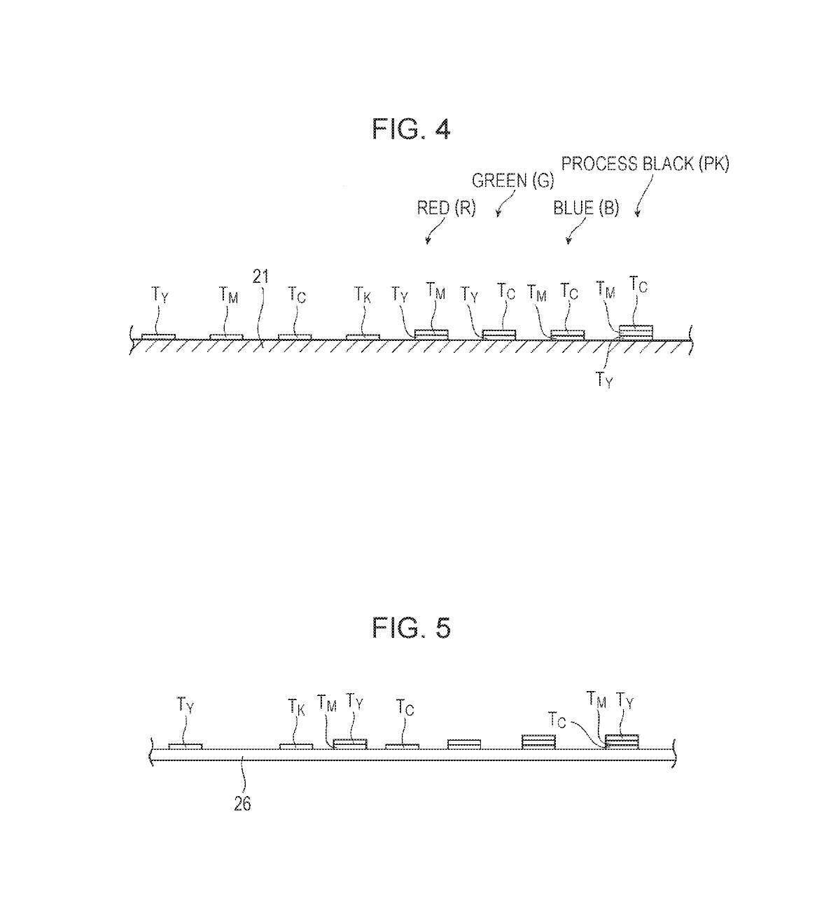

The intermediate transfer belt 21 is rotated with a period synchronized with that of the photoconductor drum 17 while holding the unfixed toner image T of, for example, yellow which has been initially subjected to first transfer. As illustrated in FIG. 4, each time the intermediate transfer belt 21 is rotated, unfixed toner images T_{M}, T_{C}, and T_{K} of magenta, cyan, and black are transferred onto the intermediate transfer belt 21 and are formed individually or on the unfixed toner image T_{Y} of yellow in a manner of being sequentially superimposed on one another.

Unfixed toner images T transferred (first transfer) onto the intermediate transfer belt 21 in the above manner are transported to the second transfer position facing the transport path of the recording paper 26 in accordance with the rotation of the intermediate transfer belt 21.

As illustrated in FIG. 2, as described above, the recording paper 26 is fed from the desired one of the paper feed cassettes 28, 29, and 30 by the paper feed roller 28a, 29a, or 30a, and is transported to the registration roller 33 by the transport rollers 31 and 32. The recording paper 26 is further fed to a pressing portion between the second transfer roller 27 and the intermediate transfer belt 21 by the registration roller 33 at a predetermined timing.

As illustrated in FIG. 3, the counter roller 25 serving as a counter electrode of the second transfer roller 27 is disposed on the back surface of the intermediate transfer belt 21 at the second transfer position. At the second transfer position, the second transfer roller 27 is always pressed against the intermediate transfer belt 21, or the second transfer roller 27 is pressed against the intermediate transfer belt 21 at a predetermined timing to apply a voltage of polarity opposite to the charging polarity of toner to the second transfer roller 27 or apply a voltage of polarity which is the same as the charging polarity of toner is applied to the counter roller 25. Therefore, the unfixed toner images T transferred onto the intermediate transfer belt 21 serving as a toner image holding member are collectively transferred (second transfer) onto the recording paper 26 at the second transfer position.

In FIG. 3, a belt cleaning device 49 cleans the front surface of the intermediate transfer belt 21. The belt cleaning device 49 is configured to be normally spaced apart from the front surface of the intermediate transfer belt 21, and to come into contact with the front surface of the intermediate transfer belt 21 at a predetermined timing.

The image forming unit 50 of the image forming apparatus may not necessarily include one photoconductor drum 17. The image forming unit 50 may include plural (for example, four) photoconductor drums corresponding to yellow (Y), magenta (M), cyan (C), and black (K) and may perform first transfer so that toner images of the respective colors formed on the photoconductor drums 17 are transferred on top of one another onto the intermediate transfer belt 21.

As illustrated in FIG. 3, the recording paper 26 onto which the unfixed toner images T have been transferred is separated from the intermediate transfer belt 21, and is delivered to the fixing device 35 (see FIG. 2) by an electrode member 47, a guide plate 48, and a transport belt 34, which are disposed downstream of the second transfer unit, to fix the unfixed toner images T.

The intermediate transfer belt 21 may be formed of a film-shaped belt of synthetic resin such as polyimide or polyamideimide or various rubbers having an appropriate amount of conductive filler such as carbon black dispersed therein which is adjusted so as to have a volume resistivity of 10⁶ to 10¹⁴ Ω.cm. The thickness of the intermediate transfer belt 21 may be set to, for example, 0.1 mm. The perimeter of the intermediate transfer belt 21 may be set to an integer multiple (for example, twice to three times) of the perimeter of the photoconductor drum 17.

The second transfer roller 27 is disposed in contact with or spaced part from the intermediate transfer belt 21, as desired. When a color image is to be formed, the second transfer roller 27 is spaced apart from the intermediate transfer belt 21 until the unfixed toner image T of the last color has been transferred (first transfer) onto the intermediate transfer belt 21. The second transfer roller 27 may be kept in contact with the intermediate transfer belt 21.

The second transfer roller 27 includes, for example, an elastic layer formed of polyurethane rubber or the like having an ion-conductivity conductive material dispersed therein. The second transfer roller 27 may be formed so as to have a volume resistivity of, for example, 10³ to 10¹⁰ Ω.cm, a roller diameter of φ28 mm, and a hardness of, for example, 30° (Asker C hardness).

The counter roller 25 includes an elastic layer formed of ethylene propylene diene monomer (EPDM) rubber having an ion-conductivity conductive material dispersed therein. The counter roller 25 may be formed so as to have a surface resistivity of, for example, 10⁷ to 10¹⁰ Ω/□, a roller diameter of φ28 mm, and a hardness of, for example, 70° (Asker C hardness).

The electrode member 47 disposed downstream of am abutting portion at the second transfer position includes a conductive plate which is preferably formed of sheet metal. In this exemplary embodiment, a stainless steel plate having a thickness of 0.5 mm may be used, and the electrode member 47 may have a needle-shaped end on the recording paper 26 side. The tip of the electrode member 47 on the second transfer unit side may be disposed at, for example, a position that is 1 mm near the second transfer roller 27 with respect to a line defined by a nip part between the counter roller 25 and the second transfer roller 27 and that is 7 mm apart from the outlet of the nip part.

In the image forming apparatus having the above configuration, as illustrated in FIGS. 2 and 3, toner images T of respective colors such as yellow (Y), magenta (M), cyan (C), and black (K) are sequentially formed on the photoconductor drum 17 in accordance with the color of the image to be formed last. The toner images T are transferred (first transfer) onto the intermediate transfer belt 21 and are formed individually or in a superimposed manner, as illustrated in FIG. 4. After that, the toner images T are collectively transferred (second transfer) onto the recording paper 26 from the intermediate transfer belt 21. Therefore, an image of the desired colors is formed.

For example, as illustrated in FIG. 4, a red image is formed by forming a two-color toner image in which a yellow (Y) toner image T_{Y} and a magenta (M) toner image T_{M} are superimposed on one another, a green image is formed by forming a two-color toner image in which a yellow (Y) toner image T_{Y} and a cyan (C) toner image T_{C} are superimposed on one another, and a blue image is formed by forming a two-color toner image in which a magenta (M) toner image T_{M} and a cyan (C) toner image T_{C} are superimposed on one another.

A black (K) image may be formed by, as illustrated in FIG. 4, forming a single-color image formed of a single-color (one color) toner image T_{K} of black (K) or forming a three-color toner image in which toner images T_{Y}, T_{M}, and T_{C} of three colors including yellow (Y), magenta (M), and cyan (C) are superimposed on one another (called process black (PK)) in accordance with user specification or an image.

In this manner, an image to be held on the intermediate transfer belt 21 serving as an image holding member is any of various types of toner images such as, as illustrated in FIG. 4, an image formed of single-color (one color) toner images T of yellow (Y), magenta (M), cyan (C), and black (K), and multiple-color toner images such as a two-color toner image T in which yellow (Y) and magenta (M) are superimposed on one another, a two-color toner image T in which yellow (Y) and cyan (C) are superimposed on one another, a two-color toner image T in which magenta (M) and cyan (C) are superimposed on one another, and a three-color toner image T in which toner image T of three colors including yellow (Y), magenta (M), and cyan (C) are superimposed on one another. The toner images held on the intermediate transfer belt 21 are collectively transferred (second transfer) onto the recording medium 26 by the second transfer roller 27, and are fixed onto the recording medium 26 by the fixing device 35.

FIG. 4 illustrates toner images transferred (first transfer) on top of one another onto the intermediate transfer belt 21. The toner images collectively transferred (second transfer) onto the recording medium 26 from the intermediate transfer belt 21 are configured such that, as illustrated in FIG. 5, the stacked toner images of the respective colors are flipped upside down.

As illustrated in FIG. 2, the image forming apparatus is configured to successively form the same image or different images on plural sheets of recording paper 26. In this case, the image forming apparatus performs control so that images formed on the plural sheets of recording paper 26 have a substantially constant density.

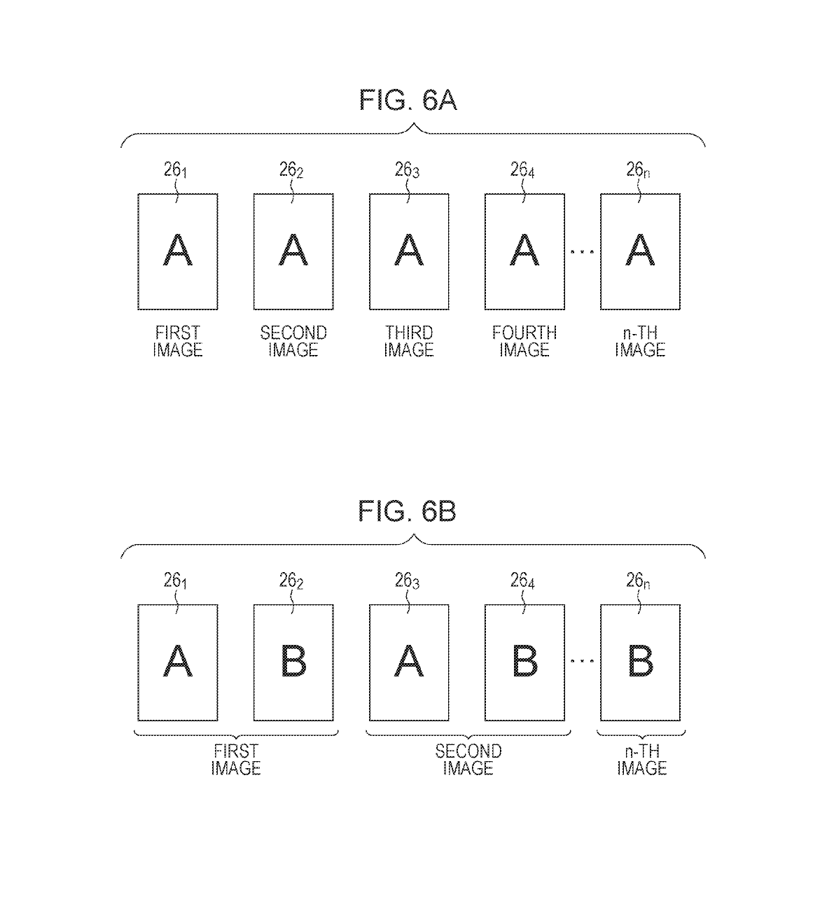

Images may be successively formed on sheets of recording paper 26 by, for example, as illustrated in FIG. 6A, forming the same image of one page continuously on plural sheets of recording paper 26₁, 26₂, 26₃, 26₄, . . . , and 26ₙ. In this case, the image formed on the first sheet of recording paper 26₁ is referred to as a “first image”, the image formed on the second sheet of recording paper 26₂ is referred to as a “second image”, and the image formed on the third sheet of recording paper 26₃ is referred to as a “third image”.

Images may also be successively formed on sheets of recording paper 26 by, for example, as illustrated in FIG. 6B, successively forming plural sets of images, each set including images of plural pages (in FIG. 6B, two pages). In this case, the first set of images of plural pages is referred to as a “first image”, the second set of images of plural pages is referred to as a “second image”, and the third set of images of plural pages is referred to as a “third image”.

In the related art, an image forming apparatus is configured to, when performing second transfer so that toner images of a single color or plural colors held on the intermediate transfer belt 21 serving as an image holding member are collectively transferred onto the recording medium 26 by the second transfer roller 27, perform constant voltage control on a transfer bias to be applied to the second transfer roller 27 when forming a first image, detect the waveform of a first current flowing in the second transfer roller 27 during the constant voltage control by using a current detection device, and determine the waveform of a second current to be applied to the second transfer roller 27 when forming a second image subsequent to the first image on the basis of the detected waveform of the first current.

The configuration of the image forming apparatus of the related art described above in which constant voltage control is performed on a transfer bias to be applied to the second transfer roller 27 when a first image is to be formed and constant current control is performed on a second current to be applied to the second transfer roller 27 when a second image subsequent to the first image is to be formed may address the increase in current value caused by reducing the resistance value of the second transfer roller 27 when the second image is formed.

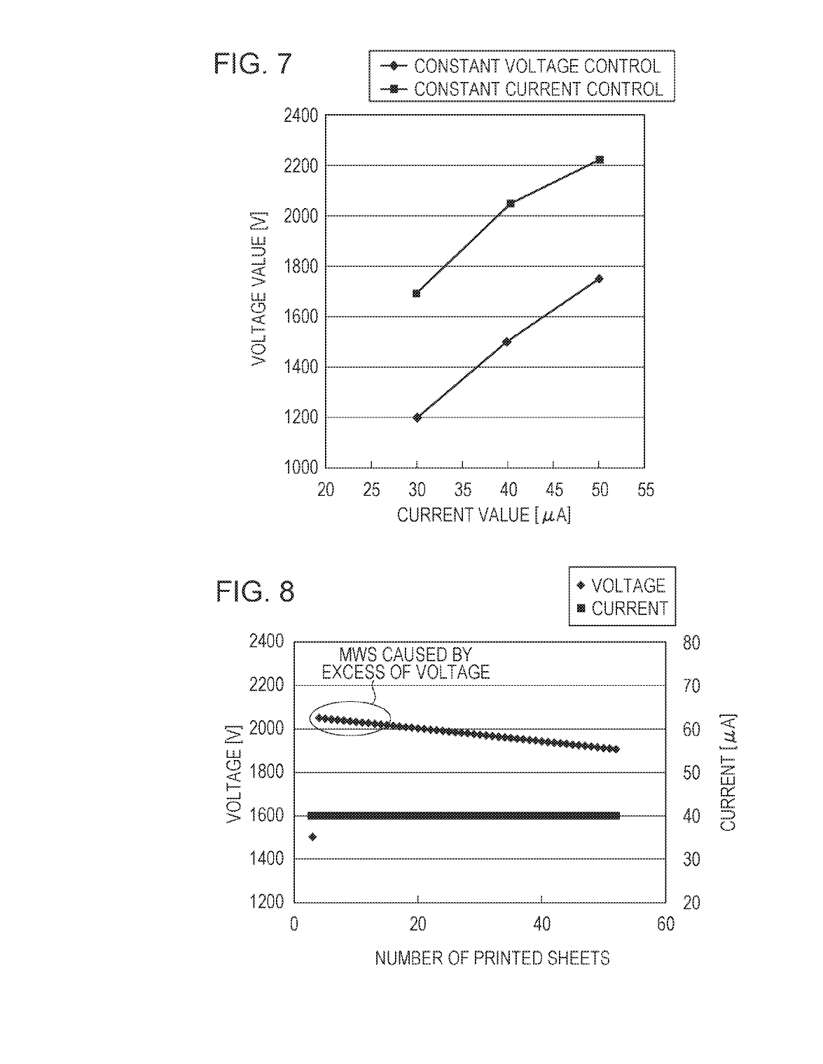

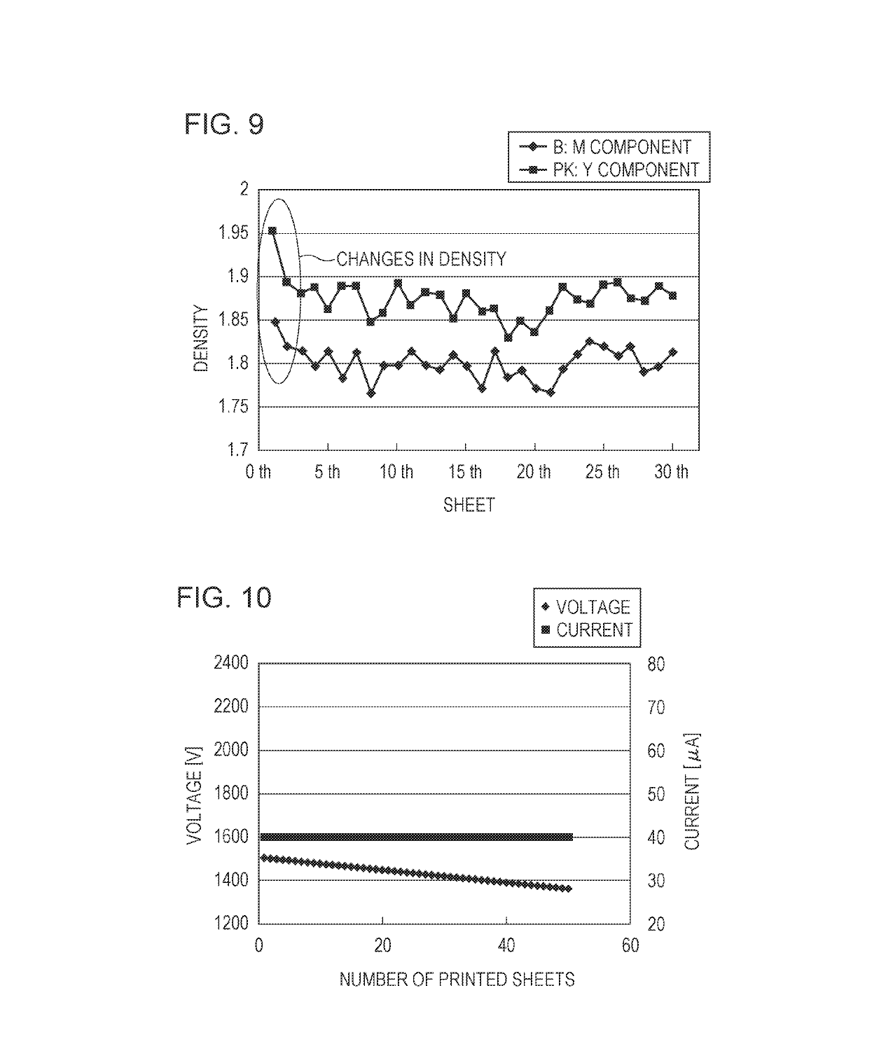

In the image forming apparatus of the related art described above, however, because of the switching from constant voltage control when forming the first image to constant current control when forming the second image, the following difficulties may arise: The voltage versus current characteristic in constant voltage control and constant current control has the relationship illustrated in FIG. 7. For example, when constant voltage control is performed so that the second transfer voltage becomes 1500 V, the current value at this voltage value is 40 μA. However, as illustrated in FIG. 8, the voltage value corresponding to a current value of 40 μA to be passed using constant current control becomes about 2050 V. That is, the second transfer voltage value largely changes. This leads to, as illustrated in FIG. 9, a large variation in image density for the first and second sheets of recording paper, and may not suppress the variation in image density during successive image formation.

A constant voltage power supply ideally has an internal impedance of zero, whereas an actual constant voltage power supply circuit has some internal impedance. Also, a constant current power supply ideally has an internal impedance of infinite, whereas an actual constant current power supply circuit has some finite internal impedance.

In the image forming apparatus of the related art described above, furthermore, as illustrated in FIG. 7, a second transfer voltage value as high as about 2050 V is applied to the second transfer roller when the switching from constant voltage control to constant current control occurs. Thus, a white spot having a size on the order of several tens to several hundreds of micrometers (μm), called a micro-white spot (MWS), may occur in a halftone image or the like, especially, in a low temperature and low humidity environment.

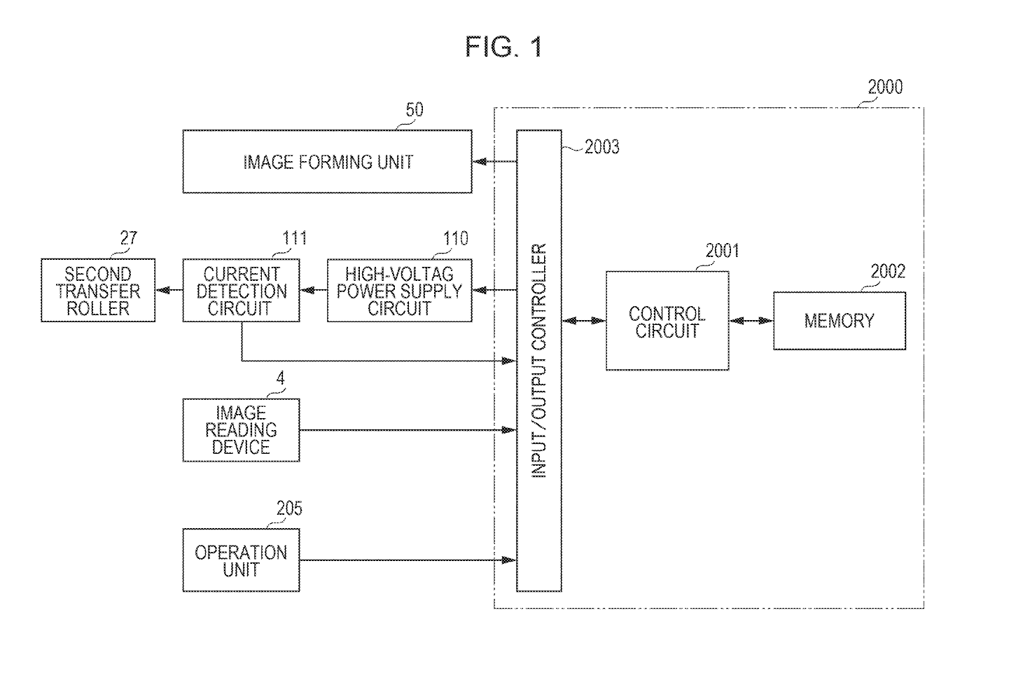

Accordingly, the image forming apparatus according to this exemplary embodiment is configured to include, as illustrated in FIG. 1, a high-voltage power supply circuit 110 serving as a constant voltage controller. When images are to be successively formed on recording media, the high-voltage power supply circuit 110 performs constant voltage control on a transfer voltage to be applied to a second transfer roller when a first image is to be formed, and performs constant voltage control on a transfer voltage to be applied to the second transfer roller when a second image is to be formed, by using a voltage value corresponding to a current value detected by a current detector. The current detector detects a transfer current passed to the second transfer roller when the first image is to be formed.

FIG. 1 is a block diagram illustrating a control circuit for the image forming apparatus according to this exemplary embodiment.

In FIG. 1, a control device 2000 controls the operation of the image forming apparatus. The control device 2000 includes a control circuit 2001 formed of, for example, a central processing unit (CPU) or the like that controls the operation of the image forming apparatus, a memory 2002 that stores a program, parameters, etc., for controlling the operation of the image forming apparatus, and an input/output controller 2003 that controls the input and output of signals.

As illustrated in FIG. 1, the control circuit 2001 is configured to control the image forming unit 50 through the input/output controller 2003, and is also configured to control a transfer voltage or transfer current to be applied to the second transfer roller 27 to a predetermined value through the high-voltage power supply circuit 110 serving as a constant voltage controller. The high-voltage power supply circuit 110 is configured to include, for example, a constant voltage control circuit. A current detection circuit 111 that detects a current value passed to the second transfer roller 27 is disposed between the high-voltage power supply circuit 110 and the second transfer roller 27. The control circuit 2001 controls the current detection circuit 111 to detect a transfer current passed to the second transfer roller 27 when a first image is to be formed, and also controls the high-voltage power supply circuit 110 serving as a constant voltage power supply to perform constant voltage control on a transfer voltage to be applied to the second transfer roller 27 when a second image is to be formed, by using a voltage value corresponding to the current value detected by the current detection circuit 111.

In this exemplary embodiment, therefore, as illustrated in FIG. 1, the high-voltage power supply circuit 110 that applies a second transfer bias to the second transfer roller 27 is provided. The high-voltage power supply circuit 110 is configured to perform constant voltage control so that a second transfer bias to be applied to the second transfer roller 27 is controlled to a predetermined constant voltage value in accordance with a control signal from the control circuit 2001.

When images are to be successively formed on sheets of recording paper 26, as illustrated in FIG. 1, the control circuit 2001 controls the high-voltage power supply circuit 110 to perform constant voltage control on a transfer voltage to be applied to the second transfer roller 27 when a first image is to be formed. A transfer current I passed to the second transfer roller 27 when the first image is to be formed is detected by the current detection circuit 111. The control circuit 2001 further controls the high-voltage power supply circuit 110 to perform constant voltage control on a transfer voltage to be applied to the second transfer roller 27 when a second image is to be formed, by using a voltage value corresponding to a current value I detected by the current detection circuit 111.

In this case, the high-voltage power supply circuit 110 basically performs constant voltage control when a first image is to be formed and when a second image is to be formed. When a first image is to be formed, the high-voltage power supply circuit 110 performs constant voltage control so that a predetermined voltage value, for example, 1500 V, is obtained. At this time, the transfer current I flowing in the second transfer roller 27 may change due to various factors such as environmental conditions, the resistance value of the second transfer roller 27, the resistance value of the counter roller 25, the material of the recording paper 26, and the resistance value of the intermediate transfer belt 21. A transfer current having a certain value I is obtained when a second transfer bias having a predetermined voltage value, for example, 1500 V, is applied, and is detected by the current detection circuit 111.

When a second image is to be formed, the high-voltage power supply circuit 110 performs constant voltage control on a transfer voltage to be applied to the second transfer roller 27, while the transfer current I is being detected by the current detection circuit 111, by using a voltage value corresponding to the current value I detected by the current detection circuit 111 when the first image is to be formed. When the second image is to be formed, constant voltage control is performed using the voltage value corresponding to the current value I detected by the current detection circuit 111, that is, using the voltage value obtained at the current value I.

The difference between the case where constant current control is performed and the case where constant voltage control is performed using a voltage value obtained at the current value I is as follows: In a case where constant current control is performed, control is performed using a circuit having an internal impedance that is ideally infinite but is actually finite so that the current becomes a constant value. In contrast, in a case where constant voltage control is performed using a voltage value obtained at the current value I, constant voltage control is performed using a circuit having an internal impedance that is ideally zero but is actually small to some extent so that the voltage becomes a value obtained at the current value I.

With the above configuration, the image forming apparatus according to this exemplary embodiment may suppress a reduction in image quality caused by constant current control when successively forming images in the following way.

In the image forming apparatus according to this exemplary embodiment, as illustrated in FIG. 2, toner images of individual colors including yellow (Y), magenta (M), cyan (C), and black (K) are sequentially formed on the photoconductor drum 17 in accordance with image data input to the image processing device 12. The toner images of the individual colors formed on the photoconductor drum 17 are sequentially subjected to first transfer so that the toner images are transferred in a superimposed manner onto the intermediate transfer belt 21. After that, the toner images are collectively subjected to second transfer by a second transfer bias applied to the second transfer roller 27 so that the toner images are transferred onto the recording paper 26 from the intermediate transfer belt 21, and the recording paper 26 is subjected to a fixing process by the fixing device 35 so that a desired image such as a full-color or monochrome image is formed on the recording paper 26.

In the image forming apparatus, as illustrated in FIG. 6A or 6B, when the same image or different images are to be successively formed on plural sheets of recording paper 26, as illustrated in FIG. 1, the high-voltage power supply circuit 110 performs constant voltage control on a transfer voltage to be applied to the second transfer roller 27 when a first image is to be formed. Additionally, the current detection circuit 111 detects the value of a transfer current I passed to the second transfer roller 27 when the first image is to be formed.

Then, in the image forming apparatus, as illustrated in FIG. 1, the control circuit 2001 controls the high-voltage power supply circuit 110 to perform constant voltage control so that a transfer voltage to be applied to the second transfer roller 27 when a second image is to be formed becomes a voltage value corresponding to the current value I detected by the current detection circuit 111.

Accordingly, as illustrated in FIG. 1, the image forming apparatus according to this exemplary embodiment is configured to perform constant voltage control on a transfer bias to be applied to the second transfer roller 27 when forming a first image, and to perform constant voltage control on a second transfer voltage to be applied to the second transfer roller 27 when forming a second image subsequent to the first image so that the second transfer voltage becomes a voltage value corresponding to the current value I, thereby preventing an excessive increase of the second transfer voltage or an increase of the transfer current even if, for example, the resistance value of the second transfer roller 27 drops during the formation of the second image.

In this exemplary embodiment, furthermore, because of the constant voltage control performed when a first image is to be formed, if constant voltage control is performed so that a second transfer voltage of, for example, 1500 V is obtained, as illustrated in FIG. 7, the current value obtained at that time becomes 40 μA.

In this exemplary embodiment, a transfer voltage to be applied to the second transfer roller 27 when a second image is to be formed is controlled so as to become a voltage value corresponding to a current value of 40 μA, which is detected by the current detection circuit 111, that is, a voltage value corresponding to a current value of 40 μA to be passed using constant voltage control, which is, as illustrated in FIG. 10, about 1497 V. Therefore, the voltage value for second transfer becomes substantially constant, thus allowing an image on the first sheet of recording paper and images on the second and subsequent sheets of recording paper to have a substantially constant density.

Experimental Example

The present inventors have made an experiment using a benchmark model of the image forming apparatus illustrated in FIGS. 2 and 3 to observe changes in the density of toner images when images are successively formed on 30 sheets of recording paper 26, which is A4 size plain paper, the images including a process black (K) solid-color image having a density of 100% that is a three-color toner image in which toner images of three colors including yellow (Y), magenta (M), and cyan (C) are superimposed on one another and a blue solid-color image having a density of 100% that is a two-color toner image in which a magenta (M) toner image T_{M} and a cyan (C) toner image T_{C} are superimposed on one another, by reading the density of the yellow (Y) toner image and the density of the magenta (M) toner image T_{M} on the front side of the recording paper 26 using a manual colorimeter by the L*a*b* color system.

Here, the reason that the density of the yellow (Y) toner image and the density of the magenta (M) toner image T_{M} on the front side of the recording paper 26 is measured is as follows. As illustrated in FIG. 4, since the yellow (Y) toner image in the image of process black (K) and the magenta (M) toner image T_{M} in the image of blue are formed in contact with the front surface of the intermediate transfer belt 21, the measurement of the densities of the yellow (Y) toner image and the magenta (M) toner image T_{M} allows the evaluation of the transfer performance at the second transfer position.

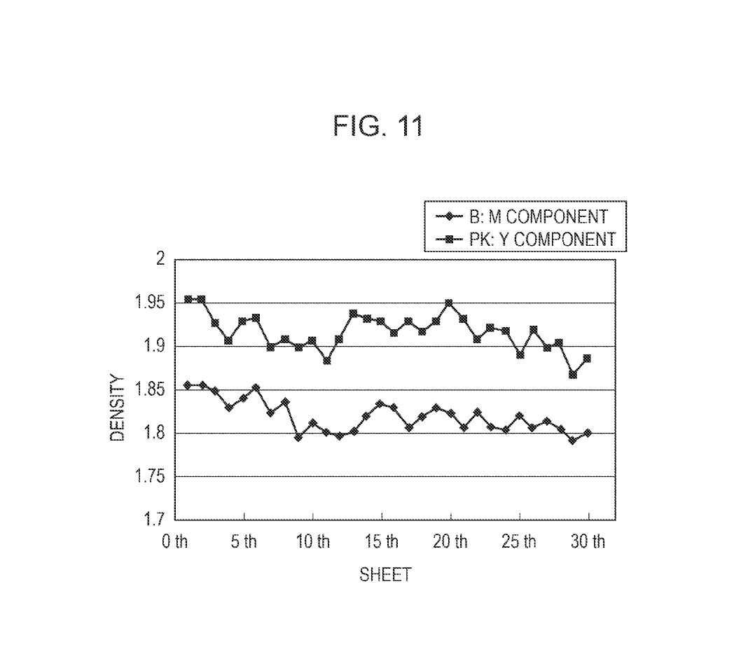

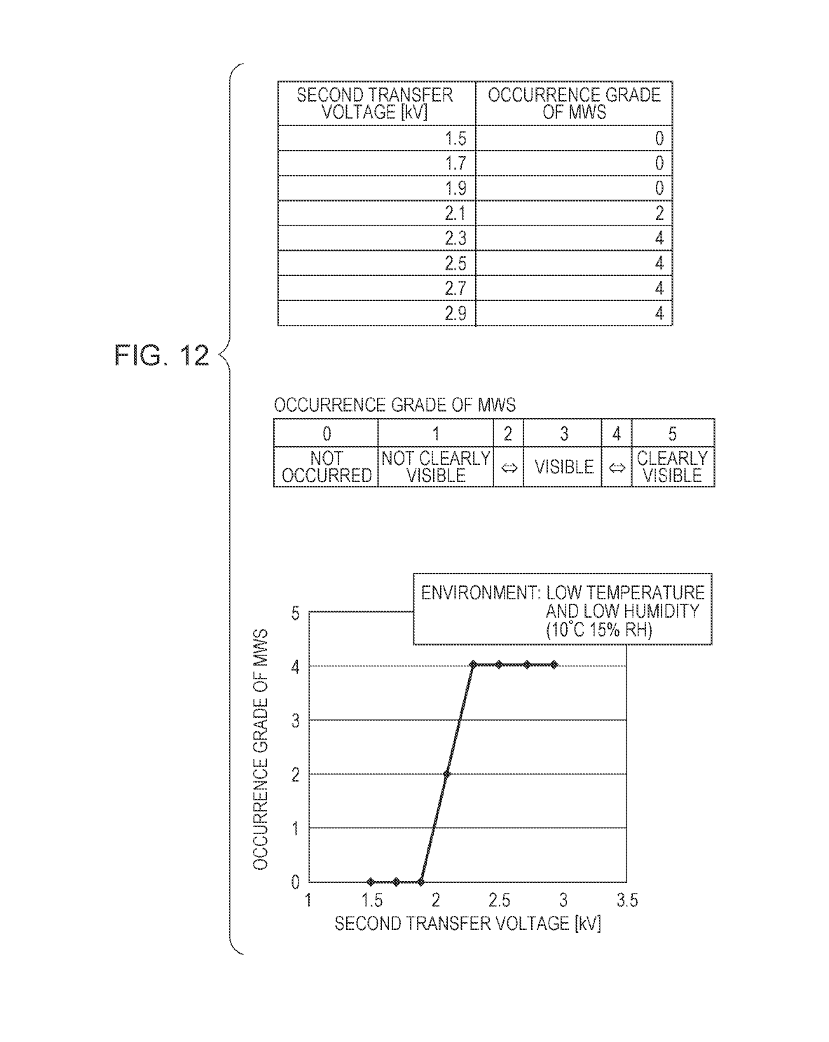

FIG. 11 illustrates results of the experiment described above.

As may be seen from FIG. 11, in the image forming apparatus according to this exemplary embodiment, the densities of the yellow (Y) toner image and the magenta (M) toner image T_{M} on the first to thirtieth sheets are kept substantially constant. In particular, no large variation in density occurs in the toner images on the first and second sheets, unlike the related art as illustrated in FIG. 8, and therefore it is found that high transfer performance is maintained.

FIG. 12 is a graph illustrating the results of evaluation of the degree (or grade) to which a white spot having a size on the order of several tens to several hundreds of micrometers (μm), called a micro-white spot (MWS), occurs in a halftone image or the like in a low temperature and low humidity environment when the second transfer voltage is changed in the image forming apparatus.

As may be seen from FIG. 12, like the image forming apparatus of the related art that performs constant voltage control when a first image is to be formed and that performs constant current control when a second image is to be formed, if the second transfer voltage is changed to over 2.1 KV or more during the formation of the first image and the formation of the second image, a micro-white spot that is visible (grade 3) or is almost clearly visible (grade 4), which is close to a clearly visible degree (grade 5), rather than not clearly visible (grade 1), occurs, leading to degradation in image quality. In the exemplary embodiment of the present invention, in contrast, the transfer voltage during the formation of the first image and the formation of the second image may be kept below 2.0 KV, leading to substantially no degradation in image quality, such as a micro-white spot, while maintaining satisfactory image transfer performance.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
an image holding member that holds a toner image;
a transfer unit that transfers the toner image held on the image holding member onto a recording medium;
a current detector that detects a transfer current passed to the transfer unit; and
a constant voltage controller that, when images including a first image and a second image are to be successively formed on recording media, performs constant voltage control on a transfer voltage to be applied to the transfer unit when the first image is to be formed and performs constant voltage control on a transfer voltage to be applied to the transfer unit when the second image is to be formed, using a voltage value corresponding to a current value detected by the current detector, the current value being a value of a transfer current passed to the transfer unit when the first image is to be formed.

2. The image forming apparatus according to claim 1, wherein the image holding member includes an intermediate transfer body onto which a plurality of toner images sequentially formed on one or a plurality of photoconductor drums are transferred one top of one another.

3. An image forming method comprising:
holding a toner image on an image holding member;
transferring the toner image held on the image holding member onto a recording medium;
detecting a transfer current passed to a transfer unit to transfer the toner image held on the image holding member onto a recording medium; and
when successively forming images including a first image and a second on recording media, performing constant voltage control on a transfer voltage to be applied to the transfer unit when forming the first image, and performing constant voltage control on a transfer voltage to be applied to the transfer unit when forming the second image, using a voltage value corresponding to a current value detected when the first image is to be formed, the current value being a value of a transfer current passed to the transfer unit when the first image is to be formed.
